(19) United States
(12) Patent Application Publication
(10) Pub. No.: US 2024/0232928 A1
(43) Pub. Date: Jul. 11, 2024

(54) METHOD AND SYSTEM FOR USING LOCATION DATA TO GENERATE AND MODIFY PURCHASE INCENTIVES IN THE METAVERSE

(71) Applicant: Richard Postrel, Miami Beach, FL (US)

(72) Inventor: Richard Postrel, Miami Beach, FL (US)

(21) Appl. No.: 18/541,699

(22) Filed: Dec. 15, 2023

Related U.S. Application Data
(60) Provisional application No. 63/477,184, filed on Dec. 24, 2022.

(51) Int. Cl. G06Q 30/0207; G06F 3/01; G06Q 30/0235

(52) U.S. Cl. CPC G06Q 30/0222; G06F 3/011; G06Q 30/0224; G06Q 30/0235

(57) ABSTRACT

Providing a purchase incentive to a user in a virtual environment such as a metaverse, based on for example the user's location in the metaverse, predicted route of travel in the metaverse, and prior transactions in the metaverse. A tracking service in the metaverse determines a number of locations of a user as they travel along a route in the metaverse and an associated timeframe when they are at each of the locations. The tracking service records the locations and associated timeframes in a location log and analyzes the location log to predict a subsequent location and associated timeframe that the user will be at that location. The tracking service then determines a merchant proximate to the predicted subsequent location of the user in the metaverse and generates a purchase incentive for use at the merchant and delivers the purchase incentive to the user.

### TECHNICAL FIELD

This invention relates to ecommerce in a virtual world environment (such as a metaverse), and in particular to the generation of a purchase incentive such as coupons, rewards, rebates and the like based on the user's location, predicted route of travel, and prior transaction history within the metaverse as well as in the real world.

### BACKGROUND OF THE INVENTION

Virtual worlds environments have become increasingly popular, due in large part to advances in computer technologies. For example, virtual reality and augmented reality has advanced to the point of allowing users to become fully immersed in one or more virtual worlds, also known as a metaverse. As known in the art, a metaverse is a computer simulation intended for users to inhabit, traverse, and interact via avatars, which are personas or representations of the users in the metaverse. Notably, users in the metaverse can execute commercial transactions with other users, analogous to commercial transactions in the real world.

As in the real world, commercial transactions may be driven by the use of purchase incentives such as coupons, rebates, discounts, reward points and the like. These tools are valuable in giving users an incentive to transact commerce with a certain merchant. In the real world, mobile commerce has benefitted greatly since the mobility of a user may be leveraged by the use of a mobile device such as a smartphone, tablet, or smart card. Since the mobile device usually has a screen and communications means such as a wireless data connection, the mobile device may be able to receive a coupon and display it to the user and merchant at which the coupon may be redeemed. The translates well into the metaverse.

As in the real world, metaverse users may have a location that changes as they traverse throughout the metaverse. It is desired to be able to leverage the location aware functionalities of the metaverse environment in order to customize a purchase incentive for a user based on their location, predicted route of travel, and prior transaction history within the metaverse. It is also desired to utilize the transaction history of the user in the real world to provide additional leverage in the metaverse.

Reference is made to U.S. Pat. No. 9,002,730 (METHOD AND SYSTEM FOR GENERATING LOCATION BASED PURCHASE INCENTIVES BASED ON PREDICTED ROUTE OF TRAVEL); U.S. Pat. No. 9,767,472 (METHOD AND SYSTEM FOR USING WI-FI LOCATION DATA FOR LOCATION BASED REWARDS); and U.S. Pat. No. 11,468,464 (METHOD AND SYSTEM FOR USING WI-FI LOCATION DATA FOR LOCATION BASED REWARDS). These patents, all by the inventor of this application, disclose and claim the use of a user's physical location in the real world to generate a purchase incentive.

In particular, the '730 patent is for a method of operating a mobile device in which a mobile device analyzes GPS coordinate data from a GPS receiver on the mobile device to determine a plurality of locations of the mobile device as the mobile device travels along a route and an associated timeframe when the mobile device is at each of the plurality of locations; the mobile device records the plurality of locations and associated timeframes in a location log stored on the mobile device, the mobile device analyzes the location log to predict a subsequent location of the mobile device and an associated timeframe that the mobile device will be at the subsequent location; the mobile device determines a merchant proximate to the predicted subsequent location of the mobile device; and the mobile device generates a purchase incentive for use by the mobile device at the merchant determined to be proximate to the predicted subsequent location of the mobile device.

The '472 patent is for a method of operating a mobile device in which a mobile device determines a plurality of locations of the mobile device as the mobile device travels along a route and an associated timeframe when the mobile device is at each of the plurality of locations by, for each of the plurality of locations, performing the steps of: the mobile device communicating via a wi-fi hot spot; the mobile device determining its location by analyzing data from the wi-fi hot spot; and the mobile device recording its location and associated timeframe in a location log. The mobile device the analyzes the location log, predicts (a) a subsequent location of the mobile device and (b) an associated timeframe that the mobile device will be at the subsequent location. As a result of analyzing the location log; prior to arriving at the predicted subsequent location, the mobile device generates a reward that is usable at the predicted subsequent location of the mobile device; and after arriving at the predicted subsequent location, the mobile device redeems the reward.

Similarly, the '464 patent is for a method of a mobile device generating a reward in which a mobile device communicates via a wi-fi hot spot, determines its location by analyzing data from the wi-fi hot spot, records its location and associated timeframe in a location log, analyzes a transaction log stored on the mobile device, the transaction log including a plurality of records of prior transactions executed by the mobile device, then automatically generates a reward as a function of the location of the mobile device, a plurality of prior locations stored in the location log of the mobile device, and prior transactions executed by the mobile device and stored in the transaction log of the mobile device; and displays the reward on a display screen.

These and other novel processes are now applied to users in the metaverse as described fully herein.

### SUMMARY OF THE INVENTION

Provided is a method for generating a purchase incentive in a metaverse comprising analyzing coordinate data of a user within a metaverse to determine a plurality of locations of the user as the user travels along a route and an associated timeframe when the user is at each of the plurality of locations within the metaverse; recording the plurality of locations and associated timeframes in a location log; analyzing the location log to predict a subsequent location of the user in the metaverse and an associated timeframe that the user will be at the subsequent location in the metaverse; determining a merchant proximate to the predicted subsequent location of the user in the metaverse; and generating a purchase incentive for use at the merchant determined to be proximate to the predicted subsequent location of the user in the metaverse.

The purchase incentive may be effective only for the timeframe associated with the predicted subsequent location in the metaverse.

Optionally, a prior transaction log associated with the user may be analyzed, the prior transaction log comprising records of prior transactions executed by the user in the metaverse; and the purchase incentive may then be generated based on the prior transaction log.

In another aspect, provided is a method for generating a purchase incentive in a metaverse comprising determining a location of a user in a metaverse; recording the location of the user and an associated timeframe in a location log in the metaverse; analyzing a transaction log comprising a plurality of records of prior transactions executed by the user in the metaverse; generating a purchase incentive as a function of the location of the user, a plurality of prior locations stored in the location log, and prior transactions executed by the user in the metaverse and stored in the transaction log; and providing the purchase incentive to the user in the metaverse.

In yet another aspect, provide is a method of generating a purchase incentive for use at a merchant in a metaverse, comprising determining a location of a user in a metaverse; determining a merchant proximate to the user in the metaverse; generating a purchase incentive for use by the user at the merchant in the metaverse; periodically evaluating the location of the user as they travel along a route in the metaverse; and modifying the purchase incentive as a function of a change in location of the user in the metaverse.

In one case, the purchase incentive is modified when the user is getting closer to the merchant, by increasing its value, decreasing its value, or changing the type of purchase incentive. In another case, the purchase incentive is modified when the user is getting farther away from the merchant, by increasing its value, decreasing its value, or changing the type of purchase incentive.

### BRIEF DESCRIPTION OF DRAWINGS

FIG. 1 is a block diagram of a preferred embodiment of the invention.

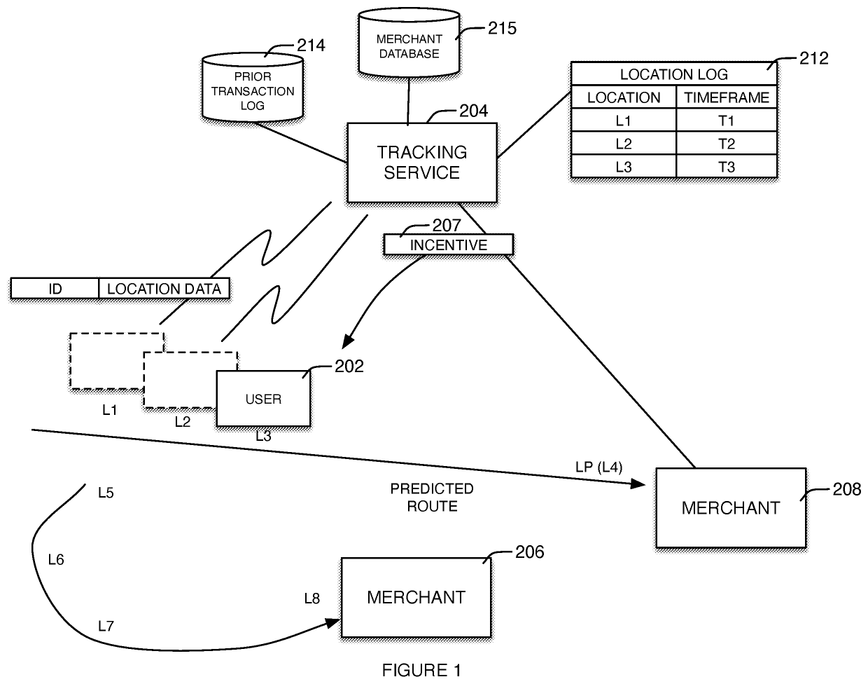

FIG. 2 is a flowchart of the operation of the preferred embodiment of the invention.

### DETAILED DESCRIPTION OF THE INVENTION

In accordance with a preferred embodiment of the present invention, a user who is engaging with a virtual world such as a metaverse (i.e., has entered or otherwise is engaged with the metaverse via well-known techniques that need not be repeated here), is associated with coordinates based on their virtual location within the metaverse.

Similarly, merchants in the metaverse have virtual locations and thus are assigned coordinates based on that location. A metaverse process referred to herein as a tracking service will be able to determine when a certain user has entered a virtual store (now referred to as a customer of that virtual store), which aisles they visit and for how long, and when the customer goes to a virtual POS checkout terminal. The tracking service may benefit from enough location-aware granularity to ascertain if a certain customer stops at a certain location in a virtual aisle of the store and how long they may dwell there.

This information is useful when used in conjunction with data obtained from a prior sale to that consumer (virtual or real world). For example, the tracking service may determine that user John Smith entered the virtual store at 3:05 PM, and proceeded to the magazine aisle, where they lingered for 15 minutes before moving on to another virtual aisle. The system will see that Smith did not purchase any magazines (only vitamins) notwithstanding his long stay in the magazine aisle. This event-based geocentric information may be utilized by the system in various ways. For example, Smith may be given a virtual coupon at his virtual checkout for a discount on a magazine, since he showed an interest in a magazine but did not purchase one. Or, he may be told by a virtual cashier that he will get increased reward points in his metaverse reward account if he purchases a magazine now or at a later date (e.g. “Mr. Smith, you will get double reward points if you purchase a magazine today or the next time you come in”). In addition, the system may use the customer location tracking information to award points and/or coupons for products sold in an area of the virtual store that was not visited by the consumer (e.g. “Mr. Smith, we see that you have not visited our gift card aisle—we would like to give you a $1 coupon (or double reward points) for you to make a purchase of an item from that aisle.”) This incentive will help drive shoppers to parts of a virtual store that may otherwise suffer from low amounts of traffic.

Virtual reward points may also be awarded based on the user simply visiting certain locations of the virtual store (or perhaps by staying near a location for a certain time period), since the tracking service can determine the virtual location of the user at any time. After the user executes a virtual transaction with the store's system, the earned reward points may be added to the user's virtual reward account accordingly. For example, a user may earn 50 points for browsing near the soda aisle, or 100 points for staying near the vitamins aisle. These points would be held temporarily by the store's system until the user checks out, thus enabling the 150 points to be added to the user's account. The location tracking may be combined with the purchases made by the user, such that browsing in a certain aisle, accompanied by the purchase of a certain product, would yield a certain number of points.

The system can also generate personalized offers based on prior shopping history as well as a user profile. For example, when a user enters a virtual store, the system may determine that he usually purchases certain items, and then the system can generate offers, coupons, or other incentives related to these products and present them to the user as soon as he enters the store. The offers may be electronically displayed to the user such as in their virtual reality headset.

A user would be able to access their account data and see the totals of each of their reward accounts and also be provided with the ability to control reward exchanges between accounts as known in the art.

A user profile may be stored in the metaverse, which would contain various information regarding the user, including but not limited to any or all of the following types of information: name, address, social security number, age, gender, income, demographics, psychographics, biometrics, names of various rewards accounts, passwords, prior purchase history including details of transactions executed, and preferences. Preferences may indicate which accounts that the user would prefer to utilize in certain situations as mentioned above; e.g. use the VISA application at supermarkets but use the AMERICAN EXPRESS application at other stores. Preferences may also indicate how the user would like to utilize reward accounts; e.g. he would prefer to pay for an item with 50% points and 50% credit, or he would prefer to pay for business expenses with credit only and personal expenses with points only, etc. These user preferences may also be utilized by the various applications stored in and executed by metaverse. For example, when the user offers to pay for gasoline for their virtual car, the purchase application may check the user profile to determine (1) which account to use unless otherwise specified, (2) how to pay for the item, e.g. with points and/or credit, etc.

The virtual merchant may utilize a scoring model to determine a user's relative worth to that merchant. That is, by analyzing profile data, including prior virtual (as well as real world) purchase transactions, as well as other user data, the merchant can assess a score to the user that will reflect the relative value of that user to the merchant. For example, if most of a user's purchases were of low margin items, then that user would have a lower score than a user that purchase more high margin items, since high margin sales are generally worth more to a merchant. That user may be provided with purchase incentives such as coupons, rebates, points, etc. that are reflective of that user's relative value as indicated by the scoring model. This incentive system will interact in real time with the user to provide optimal benefits to both the user as well as the merchant based on the parameters set forth in the scoring algorithm.

Users who provide relatively more data to their virtual profile (and allow their profile data to be used by merchants) may be provided with relatively greater virtual rewards by the participating merchants. For example, if a user is willing to share his income data with merchants, those merchants may reward him with more coupons, rebates, reward points, or other incentives, than a user that is unwilling to share his income data. Since a user's income data is valuable to a merchant, he is willing to provide a greater incentive to those users that make it available in their profiles.

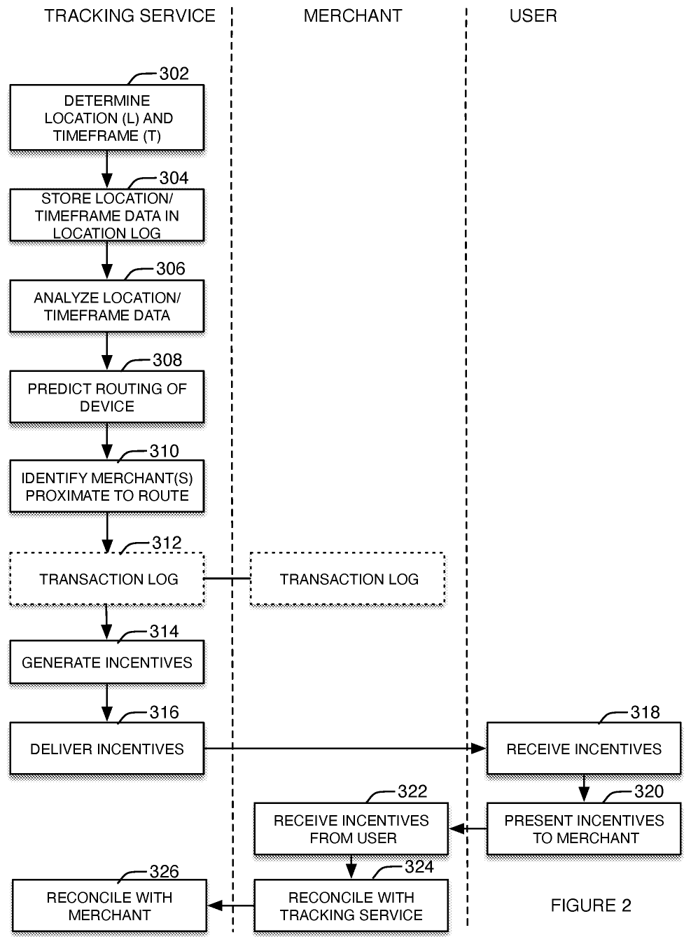

Alternative embodiments are now described. In a first alternative embodiment, reference is made to the block diagram of FIG. 2a. This embodiment is a method and system for providing a purchase incentive to a user's virtual account in the metaverse based on several parameters including but not limited to the user's virtual location, predicted route of virtual travel, and prior virtual (and real world) transaction history. FIG. 2a shows a tracking service 204, which exists in the metaverse and which is in virtual communication with a user 202 and various virtual merchants. Also shown in FIG. 2a are virtual merchant 206 and virtual merchant 208, although many more virtual merchants are contemplated by this invention.

The tracking service stores a location log 212 and a prior transaction log 214 as shown in FIG. 2a. The functions of these logs will be described further herein. As an alternative embodiment, the prior transaction log 214 and location log 212 may also be stored in association with a virtual merchant.

In this embodiment, described with reference to the flowchart of FIG. 3, the virtual location of the user within the metaverse may be monitored such that when a change in the user's virtual position greater than a predefined amount is detected then the location is updated.

At step 302, the tracking service determines the locations of the user as they travel along a route and an associated timeframe when the user is at each of the locations. The timeframe may be determined by the tracking service when it receives updated location data. The timeframe may be a duration, such as when the user stays at a location for a period of time (e.g. if the user stops for a cup of coffee at a virtual Starbucks for an hour). Or, the timeframe may be a single time if the user is in motion when he passes a certain location (such as if the user is driving). In any event, this timeframe tag is stored with the location data in a location log 212 at step 304. As shown in FIG. 2a, each record in the location log will indicate the location of the user and the timeframe that the user was at that location (and also the user ID received with the location data, not shown). As shown in FIG. 2a, the user was at location L1 at timeframe T1, and then at location L2 at timeframe T2, and then at location L3 at timeframe T3, etc.

At step 306, the tracking service 204 analyzes the location log to generate a predicted virtual route and predict a subsequent virtual location and associated timeframe that the user will be at that location at step 308. This may occur after the tracking service receives a certain amount of location data in a given time period, or it may occur periodically (e.g. every hour), or it may occur a predefined time after the first location data is received, or any other way established by the system designer. The analysis of the location log data performed by the tracking service enables it to predict a subsequent virtual location where the user is going (location predicted, or LP in FIG. 2a) and when the user will arrive at that location LP. The tracking service may implement a sequence and pattern recognition algorithm in which patterns of behavior of the user are recognized and extrapolated. In addition, the tracking service may analyze a frequency of the locations occurring in the location log. That is, the location log may indicate that this user has in the past visited locations L1, L2, and L3 in succession, and then usually will go to location L4 afterwards. L1 may be a bagel shop, L2 may be a dry cleaner, L3 may be a gas station, and L4 may be a shopping mall. This may be the usual route of this user on many Saturday mornings, so when that user again visits L1, L2 and L3 at about the same time intervals, then the tracking service predicts that L4 is the likely predicted subsequent location LP.

The tracking service may use external data sources in order to predict the estimated time of arrival of the user at the predicted subsequent location LP. For example, the location log may indicate that this user always arrives at L4 one hour after he leaves L3 on a Saturday morning. However, in this case, there is a heavy traffic pattern along the predicted route from L3 to L4, so the tracking service will modify the predicted time of arrival accordingly (e.g. from 1 to 2 hours).

Other ways to predict the route of the user may also be used with this invention. For example, the pattern of the locations stored in the location log may be analyzed over time to predict a geometrical progression. As shown in FIG. 2a, the locations L1, L2 and L3 all provide a linear progression, so the tracking service extrapolates the next stop at L4 along the same linear progression. In an alternative scenario, the user is logged as being at locations L5, L6 and L7. In this case, this geometrical progression suggests that the next stop on the user's route would be at L8 rather than L4.

The tracking service may also ascertain if the user is traveling on a certain virtual roadway as indicated by the locations in the log 212, and with reference to a mapping database as well known in the art. This information may also be used to predict the likely subsequent location of the user.

At step 310, the tracking service determines a merchant proximate to the predicted subsequent location of the user. This may be done with reference to a merchant database 215 that indicates, for each participating merchant, the location of that merchant. This merchant database 215 may be stored at the tracking service or stored elsewhere in the metaverse and referenced by the tracking service when necessary. The tracking service can compare the predicted subsequent location to the database of participating merchant locations and determine which merchants are proximate to the predicted subsequent location of the user. As shown in FIG. 2a, merchant 208 has been determined to be proximate to the predicted subsequent location LP of the user.

At step 314, the tracking service generates a purchase incentive 207 for use at merchant 208, since that merchant 208 has been determined to be proximate to the predicted subsequent location of the user.

Generation of the purchase incentive may occur on the occurrence of a triggering event. There are two main types of triggering events that may be used to initiate generation of the purchase incentive. In one type, referred to as a push embodiment, the triggering event is automated and based on a predetermined condition. This predetermined condition is set by the system designer, and may be for example when there are a certain number of location records received and stored in the location log, or at the time that the user is within a predetermined distance of the predicted subsequent location, etc.

Other conditions may be used to automatically trigger the purchase incentive generation as desired. In one embodiment, a user may set the conditions in a program interface of the metaverse system. The conditions may include the type of purchase incentive (e.g. send food coupons immediately, hold coupons for household items until distance to merchant is less than X), value of purchase incentive (e.g. send $10 coupons immediately, hold lesser value coupons until within 2 miles of merchant), time of redemption, identification of merchant, etc.

In a second type, referred to as a pull embodiment, the purchase incentives are not generated unless and until a user requests it. In this case, the user would make a selection, which would cause an incentive request signal to be sent to the tracking service. On receipt of this user request, the tracking service would then generate (and deliver) the purchase incentive. These embodiments may be combined, so that a purchase incentive is generated (and delivered) to the user on the occurrence of a predefined condition (push) as well as when a user request is made (pull).

It is also noted that the triggering events described above may be used in conjunction with other steps in the process, for example the delivery of the incentive to the user. In this case, the incentives would be automatically generated but not delivered until the trigger condition is satisfied.

At step 316, the tracking service delivers the purchase incentive 207 to the user. This may be optionally displayed to the user on the user's display device, such as a VR headset. A notification may also be generated, which may be visual (display of the incentive or a message indicating the receipt of the incentive), audible (a tone may be generated), and/or tactile (the device may be caused to vibrate).

The purchase incentive may be for example a discount or other type of coupon, rebate, offer of reward points, etc. The purchase incentive may be made effective only for a time period associated with the predicted time that the user will be at the predicted location. For example, the incentive may be a $10 discount coupon effective only between 11 AM and 1 PM when it is predicted that the user will arrive at the predicted location at 11 AM. The parameters of the purchase incentive 207 may be predetermined by the merchant 208 and stored at the tracking service. The incentive parameters may be based on any factors established by the merchant such as “give all users a 15% discount on Saturdays”, or “give all repeat users a $20 coupon for electronics on Friday nights”, etc.

The user may then present at step 320 the received incentive to the merchant 208 to redeem it as part of a virtual purchase transaction at that merchant 208, and at step 322 the merchant 208 receives the incentive 207 from the user. This may be accomplished in various ways. For example, the incentive may be transferred from the user's account to the merchant account. Or, the incentive 207 may simply be displayed and read by the merchant 208 to be applied to the purchase. At some point after (or even during) the purchase transaction is executed, the merchant at steps 324 and 326 will reconcile the purchase incentive with the tracking service 204. Optionally, the purchase incentive may be made available for a real world purchase with a real world merchant associated with the virtual merchant.

In a variation of this embodiment, the tracking service may at step 312 analyze a prior transaction log 214 associated with the user, which includes records of prior transactions executed by the user virtually or in the real world. In a simple case, the prior transactions may be stored as a result of the merchant reconciliation process described above. In this case, each time a purchase incentive 207 is delivered by the tracking service to the user, a record is made in the prior transaction log, and each time that purchase incentive 207 is redeemed with a merchant, a record is made in the prior transaction log. Or, prior transactions may include purchases made by user as may be obtained from various external sources such as credit card transactions, etc. The prior transaction log 214 is preferably stored at the tracking service 204, but it may also be stored elsewhere in the metaverse (such as the merchant). Alternatively, the prior transaction log may be stored on an external third party server computer in the real world and accessed as needed.

In this variation, the tracking service 204 generates the purchase incentive at step 314 based also on the prior transaction log 214. For example, the merchant 208 may establish that all users who have made twenty or more purchases at that merchant be given a greater discount than those users who have made less than twenty purchases at that merchant. In another example, the purchase incentive is based on a type of prior transactions, or, the purchase incentive is based on a value of prior transactions. In another example, the tracking service may generate a purchase incentive for use with a merchant associated with the prior transaction log, or for use with a merchant not associated with the prior transaction log.

In a further embodiment, the merchant generates the purchase incentive (rather than the tracking service) and provides the purchase incentive back to the tracking service which then delivers it to the user. The functionality described above is utilized in this embodiment, except that the merchant performs the tracking and incentive generation functions rather than the tracking service.

In a further embodiment of the invention, the merchant again generates the purchase incentive (rather than the tracking service) but delivers the token directly to the user (rather than through the tracking service). The functionality described above is utilized in this embodiment, except that the merchant performs the tracking and incentive generation functions, thus obviating the requirement of a centralized tracking service.

Optionally, in all of the embodiments described above, the purchase incentive may be modified as a function of a change in location of the user. That is, when the user is determined to be within a certain range of a merchant, the purchase incentive is generated as described in the various embodiments above. Then, as the user travels and the distance from the user to the merchant changes, the location of the user is periodically re-evaluated, and the purchase incentive is modified when it is determined that the user is getting closer to (or further away from) the merchant.

The system can be configured to modify the purchase incentive as a function of a change in location of the user in one or more of several ways. In one case, the purchase incentive may be modified as the user gets closer to the merchant. For example, the value of the purchase incentive may be modified as the user gets closer to the merchant, such as by increasing (or optionally decreasing) the value of a discount coupon. In the alternative, the type of purchase incentive may change as the user gets closer to the merchant. For example, the purchase incentive my initially be a discount coupon, but it may change to a free offer (such as buy one get one etc.) as the user gets closer to the merchant, or a package deal (such as buy a TV get a free Bluetooth speaker) as the user gets closer to the merchant. By making the purchase incentive more valuable as the user gets closer to the merchant in any of these or other ways, the user is rewarded for getting closer and incentivized to continue to get closer to the merchant.

In the alternative, the purchase incentive may be modified as the user gets farther away from the merchant. For example, the value of the purchase incentive may be modified as the user gets farther away from the merchant, such as by decreasing (or optionally increasing) the value of a discount coupon. In the alternative, the type of purchase incentive may change as the user gets farther away from the merchant. For example, the purchase incentive my initially be a free offer (such as buy one get one etc.), but it may change to a discount coupon as the user gets farther away from the merchant, or a package deal (such as buy a TV get a free Bluetooth speaker) as the user gets farther away from the merchant. By making the purchase incentive more valuable as the user gets farther away from the merchant in any of these or other ways, the user is incentivized to reverse direction to get closer to the merchant. Or, by making the purchase incentive less valuable as the user gets farther away from the merchant in any of these or other ways, the user is punished for going farther away from the merchant and thus incentivized to reverse direction to get closer to the merchant.

As a result, the reward or purchase incentive changes like a treasure map becoming more or less valuable or interesting, ultimately culminating with a purchase. This makes the user's interaction with the merchant a gamification of travelling throughout the metaverse and further incentivizes the user to ultimately transact with the merchant.

Thus, in the first embodiment wherein the tracking service generates the purchase incentive and sends it to the user, the purchase incentive may be modified as described above by the tracking service as a function of a change in location of the user gets closer to (or farther away from) the merchant, as determined by the tracking service's periodic evaluation of the location and path of the user. Similarly, in the embodiment wherein the merchant computer generates the purchase incentive (rather than the tracking service) and provides the token back to the tracking service which delivers it to the user, the purchase incentive may be modified as described above by the tracking service as a function of a change in location of the user as they get closer to (or farther away from) the merchant, as determined by the tracking service's periodic evaluation of the location and path of the user. In the embodiment wherein the merchant computer generates the purchase incentive (rather than the tracking service computer) and delivers the token directly to the user (rather than through the tracking service computer), the purchase incentive may be modified as described above by the merchant computer as a function of a change in location of the user as they get closer to (or farther away from) the merchant, as determined by the tracking service's periodic evaluation of the location and path of the user.

In all of the embodiments described herein, the user may optionally be given the ability to select a distance from their location within which they would like to receive purchase incentives from merchants within that distance. Thus, for example, the user may select one mile, and they will be provided with purchase incentives from merchants that are one mile or less away from them. Or, they may select two miles, and they would receive purchase incentives from merchants that are two miles or less away from them. In this manner, the user can filter out merchants that they consider to be too far to travel to at that time.

Furthermore, in all of the embodiments described herein, users who provide relatively more data to their profile (and allow their profile data to be used by merchants) may be provided with relatively greater rewards by the participating merchants. For example, if a user is willing to share his income data with merchants, those merchants may reward him with more coupons, rebates, reward points, or other incentives, than a user that is unwilling to share his income data. Since a user's incomes data is valuable to a merchant, they are willing to provide a greater incentive to those users that make it available in their profiles.

Additionally, in all of the embodiments described above, a countdown clock or timer may be implemented to provide limits on the incentives. For example, the offer contained in the incentive may only be valid for a certain time period, and once that time period is over the incentive is eliminated or reduced to some degree. In another example, a predetermined limit on the number or value of incentives may be made available, such that once that limit is reached, the incentives are no longer offered.

What is claimed is:

1. A method for generating a purchase incentive in a metaverse comprising:
a. analyzing coordinate data of a user within a metaverse to determine a plurality of locations of the user as the user travels along a route and an associated timeframe when the user is at each of the plurality of locations within the metaverse;
b. recording the plurality of locations and associated timeframes in a location log;
c. analyzing the location log to predict a subsequent location of the user in the metaverse and an associated timeframe that the user will be at the subsequent location in the metaverse;
d. determining a merchant proximate to the predicted subsequent location of the user in the metaverse; and
e. generating a purchase incentive for use at the merchant determined to be proximate to the predicted subsequent location of the user in the metaverse.

2. The method of claim 1 wherein the purchase incentive is effective only for the timeframe associated with the predicted subsequent location in the metaverse.

3. The method of claim 1 further comprising:
a. analyzing a prior transaction log associated with the user, the prior transaction log comprising records of prior transactions executed by the user in the metaverse; and
b. generating the purchase incentive based on the prior transaction log.

4. A method for generating a purchase incentive in a metaverse comprising:
a. determining a location of a user in a metaverse;
b. recording the location of the user and an associated timeframe in a location log in the metaverse;
c. analyzing a transaction log comprising a plurality of records of prior transactions executed by the user in the metaverse;
d. generating a purchase incentive as a function of the location of the user, a plurality of prior locations stored in the location log, and prior transactions executed by the user in the metaverse and stored in the transaction log; and
e. providing the purchase incentive to the user in the metaverse.

5. A method of generating a purchase incentive for use at a merchant in a metaverse, comprising:
a. determining a location of a user in a metaverse;
b. determining a merchant proximate to the user in the metaverse;
c. generating a purchase incentive for use by the user at the merchant in the metaverse;
d. periodically evaluating the location of the user as they travel along a route in the metaverse; and
e. modifying the purchase incentive as a function of a change in location of the user in the metaverse.

6. The method of claim 5 wherein the purchase incentive is modified when the user is getting closer to the merchant.

7. The method of claim 6 wherein the purchase incentive is modified by increasing its value.

8. The method of claim 6 wherein the purchase incentive is modified by decreasing its value.

9. The method of claim 6 wherein the purchase incentive is modified by changing the type of purchase incentive.

10. The method of claim 5 wherein the purchase incentive is modified when the user is getting farther away from the merchant.

11. The method of claim 10 wherein the purchase incentive is modified by increasing its value.

12. The method of claim 10 wherein the purchase incentive is modified by decreasing its value.

13. The method of claim 10 wherein the purchase incentive is modified by changing the type of purchase incentive.
